(19) United States
(12) Patent Application Publication
(10) Pub. No.: US 2012/0301680 A1
(43) Pub. Date: Nov. 29, 2012

(54) Composite Board

(75) Inventor: Lung Tak To, Kowloon (HK)

(73) Assignee: DURA PLY COMPANY LIMITED, Kowloon (HK)

(21) Appl. No.: 13/575,178

(22) PCT Filed: Jan. 14, 2011
(86) PCT No.: PCT/CN2011/070283

§ 371 Date: Jul. 25, 2012

(30) Foreign Application Priority Data
Feb. 10, 2010 (HK) 10101505.4

(51) Int. Cl. B32B 3/02

(52) U.S. Cl. 428/172; 428/192; 428/189

(57) ABSTRACT

The present invention discloses a composite board comprising a first panel board; a second panel board aligned with the first panel board; and edge seals mounted along edges of the first and second panel boards. The first and second panel boards are made of fiberglass-reinforced plastics. Therefore, it is convenient for control the quality of the composite board of the present invention, and the composite board is not subject to damages.

### FIELD OF THE INVENTION

The present invention generally relates to a composite board, and more particularly to a composite board used in construction and decoration.

### BACKGROUND OF THE INVENTION

Currently, wood boards or plywood are widely used as sheet materials in field of architectural or decorating engineering. However, as sheet materials used in engineering, the wood boards and plywood are of the following disadvantages:
1. Each plywood is manufactured by adhering several layers of natural wood plates. As wood plates are natural material, their quality could not be controlled. Therefore, it is difficult to ensure the quality of the plywood made of natural wood plates.
2. The wood plates of plywood are adhered by means of adhesive. However, under influence of water, the wood plates would expand resulting in separation of the wood plates. Then, the structure of the whole plywood would be damaged.
3. The mechanical performance of wood boards and plywood is closely related to water content therein. At construction sites, the wood boards and plywood are affected by the weather and circumstance of the sites, and thereby the water content therein could not be controlled. Therefore, it is difficult to ensure the performance of the wood boards and plywood.
4. If the wood boards and plywood are wet, they would deform and could not function normally.
5. If the wood boards and plywood are damaged, they could not be repaired. For example, if their surfaces need puncturing, the punctured holes could not be repaired.
6. Taking into account of the weight, the wood boards and plywood are heavy, and thus not convenient for operation.
7. The manufacture of wood boards and plywood needs a plenty of wood, which would destroy the natural environment.
   Due to the above-mentioned various shortcomings of the wood boards and plywood, it is desirable to provide a novel sheet material for construction and decoration to replace such wood boards and plywood.

### SUMMARY OF THE INVENTION

To overcome the above-mentioned shortcomings, the present invention aims to provide a composite board which may comprise a first panel board; a second panel board aligned with the first panel board; and edge seals mounted along edges of the first and second panel boards.

The first and second panel boards could be made of fiberglass-reinforced plastics.

The edge seals could be edge sealing strips sandwiched between the first and second panel boards, and each edge of the first and second panel board could be provided with one or more edge sealing strips, in which the outermost edge sealing strip extends along the whole length of the edge to close the edge, while the inner edge sealing strips extend along the whole length or part of length of the edge. The edge sealing strips may be made of fiberglass-reinforced plastics, and a cross section of each edge sealing strip is in the shape of solid rectangle, hollow rectangle, I-shape, C-shape.

Preferably, the composite board may further comprise one or more supports sandwiched between the first and second panel boards. The supports could include longitudinal supporting strips and transverse supporting strips crossing the longitudinal supporting strips.

One or more longitudinal supporting strips may be sandwiched between the first and second panel boards, while one or more transverse supporting strips may be sandwiched between the first and second panel boards which crossing the longitudinal supporting strips. The cross sections of the longitudinal and transverse supports could be in the shape of C-shape, I-shape, hollow rectangle or solid rectangle. The longitudinal and transverse supports could be made of fiberglass-reinforced plastics.

Either the longitudinal supporting strips or the transverse supporting strips have a cross section in the shape of hollow rectangle or solid rectangle, while each of the other of the longitudinal and transverse supporting strips is provided with spaced notches at a side thereof facing to said either the longitudinal supporting strips or the transverse supporting strips, in which the number of the notches is the same as the number of said either the longitudinal supporting strips or the transverse supporting strips, the width of each notch is slightly larger than the thickness of each of said either the longitudinal supporting strips or the transverse supporting strips, and the depth of each notch is slightly larger than half height of each of said either the longitudinal supporting strips or the transverse supporting strips, each longitudinal supporting strip and each transverse supporting strip are engaged with each other at corresponding notches.

Alternatively, either the longitudinal supporting strips or the transverse supporting strips have a I-shaped or C-shaped cross section, while each of the other of the longitudinal and transverse supporting strips is provided with spaced notches at a side thereof facing to said either the longitudinal supporting strips or the transverse supporting strips, in which the number of the notches is the same as the number of said either the longitudinal supporting strips or the transverse supporting strips, the width of a top of each notch is slightly larger than the thickness of a top of each of said either the longitudinal supporting strips or the transverse supporting strips, the width of a bottom of each notch is slightly larger than the thickness of each of said either the longitudinal supporting strips or the transverse supporting strips, and the depth of each notch is slightly larger than half height of each of said either the longitudinal supporting strips or the transverse supporting strips, each longitudinal supporting strip and each transverse supporting strip are engaged with each other at corresponding notches.

Otherwise, a cross section of each longitudinal and transverse supporting strip is in the shape of solid rectangle, hollow rectangle, I-shape or C-shape, each longitudinal supporting strip is provided with a plurality of spaced upper notches and spaced lower notches at a upper and lower side thereof respectively and each upper notch is aligned with a corresponding lower notch, each transverse supporting strip is provided with a plurality of spaced openings in the middle part of the height thereof along its length, in which the height of each opening is slightly larger than the height of the longitudinal supporting strip between a pair of aligned upper and lower notches, while the width of the opening is slightly larger than the maximum height of the longitudinal supporting strip, a pair of the upper and lower notches of one of the longitudinal supporting strips are attached to one of the transverse supporting strips within a corresponding opening to enable the longitudinal supporting strip and the transverse supporting strip to be engaged with each other.

Or, the edge seals may be formed by directly coating either of marble glue, epoxy resin, unsaturated polyester resin onto the edges of the first and second panel boards.

Alternatively, the edge seals are exterior edge seals attached to a periphery of the first and second panel boards to close an inner space between the first and second panel boards, and each of which comprises a main body attached to the periphery of the first and second panel boards, and a protrusion extending from a side of the main body facing to the first and second panel boards towards the first and second panel boards for supporting the outer surface of the first or second panel board.

Or, each of the edge seals comprises a side strip attached to a periphery of the first and second panel boards, a plurality of upper protrudes formed at a upper part of the side strip and spaced from each other, and a plurality of lower protrudes formed at a lower part of the side strip and aligning with the upper protrudes, in which both the upper protrudes and lower protrudes extend from a side of the side strip facing to the first and second panel boards towards an inner space between the first and second panel boards, to supporting inner surfaces of the first and second panel boards.

Preferably, the composite board may further comprise corner protectors sandwiched between the first and second panel boards at corners of the latter, and each corner protector includes a main body made of fiberglass-reinforced plastics.

Each corner protector may further include a coating covering exposed sides of the main body, and the coating is made of metals or alloys, and the main body of each corner protector has a triangle-shaped or rectangle-shaped cross section.

If a cross section of each edge seal is in the shape of hollow rectangle, each corner protector may further comprise one or more projections extending outwards from adjacent sides of the main body facing to the internal of the composite board, the projections are inserted into through holes of the edge seals.

In addition, the composite board may further comprise stuffing filling an inner space formed between the first and second panel boards, in which the stuffing is made of light foam and the light foam is at least one of expanded polystyrene, extruded polystyrene, polyurethane, polyvinylidene chloride, polyetherimide, acrylonitrile styrene copolymer, polymethacrylimide and thermoplastic polyethylene. The light foam could be coated with protective agent made of a mixture of white adhesive cement and speckstone powder.

The composite board of the present invention is mainly made of fiberglass-reinforced plastics, and thereby it is easy to control the quality of the composite board, and the composite board is not so easily damaged. Even damaged, it is easy to repair the composite board through a simple procedure. Furthermore, such composite board is not subject to influence of wet environment, thus the durability and lifespan of the present composite board are better than the conventional wood boards and plywood. In addition, the present composite board is light in weight. Similar to the wood boards and plywood, the present composite board is very convenient for operation.

### BRIEF DESCRIPTION OF THE DRAWINGS

The present invention will be described in details with reference to the accompanying drawings, which are for illustration purposes only and are not drawn to scale, in which:

FIG. 1 is a cross-sectional view of a first embodiment of the composite board according to the present invention;

FIG. 2 is a top plan view of the composite board shown in FIG. 1, in which a first panel board is removed;

FIG. 3 is an enlarged cross-sectional view of an edge seal of the composite board shown in FIG. 1;

FIG. 4 is an enlarged cross-sectional view of another form of the edge seal of the composite board according to the present invention;

FIG. 5 is an enlarged cross-sectional view of an exterior edge seal of the composite board according to the present invention;

FIG. 6 is an enlarged cross-sectional view of a variant of the exterior edge seal of the composite board according to the present invention;

FIG. 7 is an enlarged cross-sectional view of another variant of the exterior edge seal of the composite board according to the present invention;

FIG. 8 is an enlarged view of a further form of the edge seal of the composite board according to the present invention;

FIG. 9 is a schematic cross-sectional view of longitudinal and/or transverse supports of the composite board shown in FIG. 1;

FIG. 10 is a schematic view illustrating an engagement manner between a longitudinal support and a transverse support of the composite board shown in FIG. 1;

FIG. 11 is a schematic view illustrating another engagement manner between a longitudinal support and a transverse support of the composite board shown in FIG. 1;

FIG. 12 is a top plan view of a second embodiment of the composite board according to the present invention, in which a first panel board is removed;

FIG. 13 is an enlarged view of a corner protector of the composite board shown in FIG. 12; and

FIG. 14 is an enlarged view illustrating the engagement of the corner protector and the edge seals of the composite board shown in FIG. 12.

### DETAILED DESCRIPTION OF THE INVENTION

In conjunction with the accompanying drawings, the composite board of the present invention would be described in details.

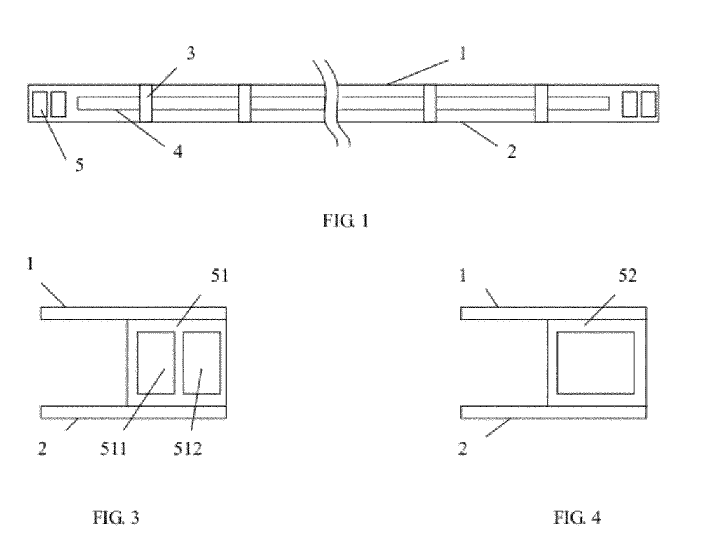

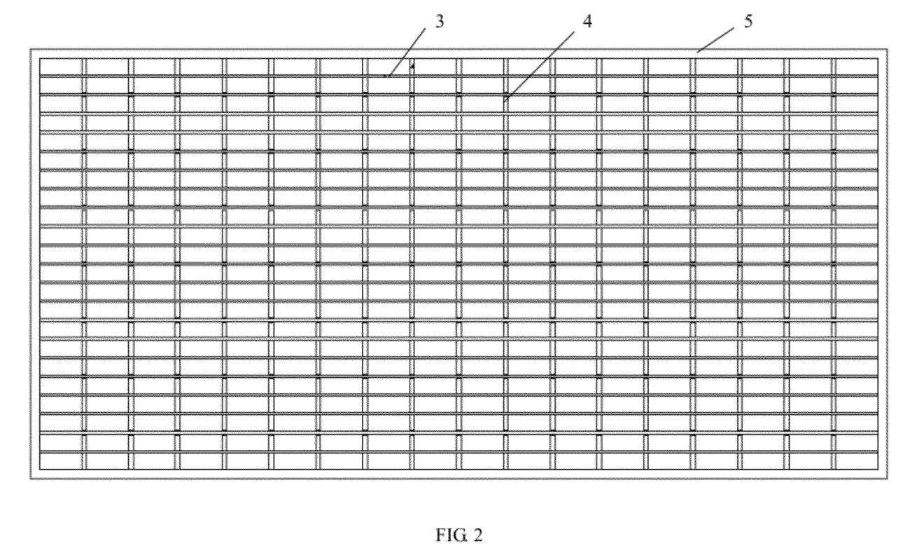

As shown in FIGS. 1 and 2, the first embodiment of the composite board of the present invention comprises a first panel board 1, a second panel board 2 aligned with the first panel board, one or more longitudinal supports 3 sandwiched between the first and second panel boards, one or more transverse supports 4 sandwiched between the first and second panel boards and crossing the longitudinal supports, and edge seals 5 mounted along edges of the first and second panel boards.

According to different application situations, the first and second panel board 1 and 2 could be made of a variety of materials, such as fiberglass-reinforced plastics. Besides, the thickness of the first panel board 1 or the second panel board 2 could be adapted according to the uses thereof. Preferably, the thickness of the first panel board 1 or the second panel board 2 may be 0.5 mm-10 mm.

FIG. 3 is a schematic view of a structure of the edge seal of the composite board according to the present invention. The edge seal 5 is in form of a rectangle-shaped edge sealing strip 51, and through holes 511 and 512 separated from each other are formed within the central part of the edge sealing strip 51 along the length of the latter. Therefore, the edge sealing strip 51 could ensure good resistance of the composite board to relatively strong impact.

As shown in FIG. 4, the through holes within another edge sealing strip 52 could be combined into a single through hole, to lower the weight of the edge sealing strip, and still ensure the good resistance of the composite board to relatively strong impact at the same time. Alternatively, there may be three or more through holes within the edge sealing strip, to be satisfied with different application situations. Of course, the cross section of the edge sealing strip could be in the shape of solid rectangle, I-shape, or C-shape.

In addition, according to different requirements, each edge of the composite board could be provided with one or more edge sealing strips. If an edge of the composite board is provided with more than one edge sealing strip, the outermost edge sealing strip extends along the whole length of the edge, to enable to close the inner space formed between the first and second panel boards. The inner edge sealing strips could extend along the whole or part of the edge of the composite board, to provide additional protection to particular parts of the composite board.

According to different application situations, the edge sealing strips could be made of a variety of materials, such as fiberglass-reinforced plastics. Besides, the thickness of wall, width and height of each edge sealing strip could be adapted according to the uses thereof. Preferably, the thickness of wall of the edge sealing strip may be 0.1 mm-10 mm, the width may be 1 mm-200 mm, while the height may be 5 mm-450 mm.

Alternatively, the edge seal 5 could be formed by directly coating either of marble glue, epoxy resin, unsaturated polyester resin onto the edges of the first and second panel boards.

Alternatively, as shown in FIG. 5, the edge seal 5 could be in form of an exterior edge seal 53 attached to the periphery of the first and second panel boards, to enable to close the inner space between the first and second panel boards. Each exterior edge seal 53 comprises a main body 531 attached to the periphery of the first and second panel boards, and a protrusion 532 extending from a side of the main body 531 facing to the first and second panel boards towards the first and second panel boards for supporting the outer surface of the first or second panel board.

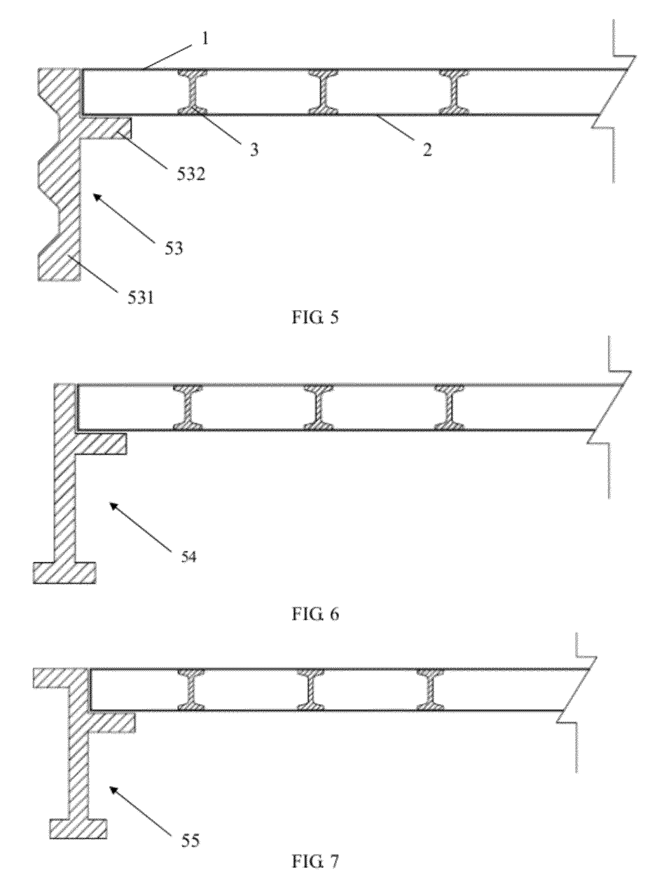

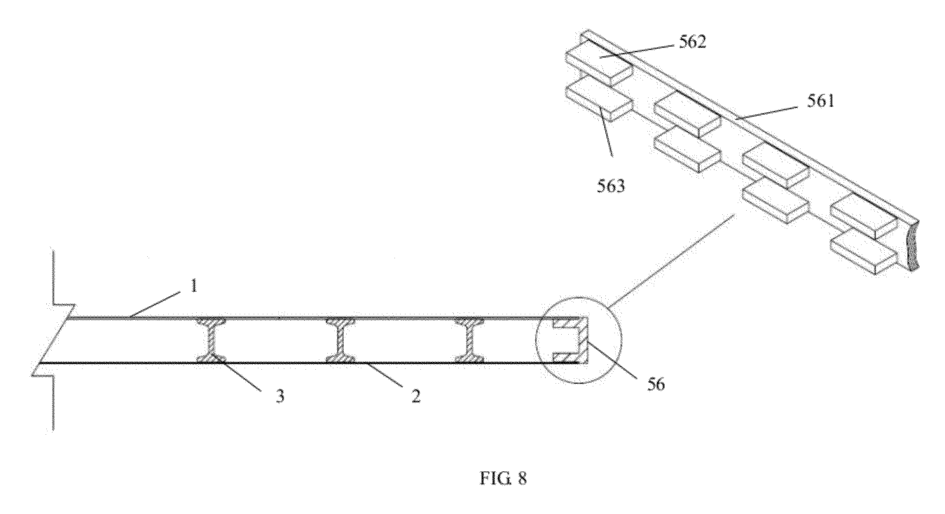

FIGS. 6 and 7 illustrate variants 54 and 55 of the exterior edge seal. Except for the structure of the main body, the other parts of the exterior edge seals 54 and 55 as well as the engagement thereof with the first and second panel boards are the same as those of the exterior edge seal 53 shown in FIG. 5.

Alternatively, the edge seal 5 may further be constructed as an edge sealing strip 56 shown in FIG. 8. The edge sealing strip 56 comprises a side strip 561 attached to the periphery of the first and second panel boards 1 and 2, a plurality of upper protrudes 562 formed at the upper part of the side strip 561 and spaced from each other, and a plurality of lower protrudes 563 formed at the lower part of the side strip 561 and aligning with the upper protrudes 562, in which both the upper protrudes 562 and lower protrudes 563 extend from a side of the side strip 561 facing to the first and second panel boards towards the inner space between the first and second panel boards, to supporting the inner surface of the first and second panel boards.

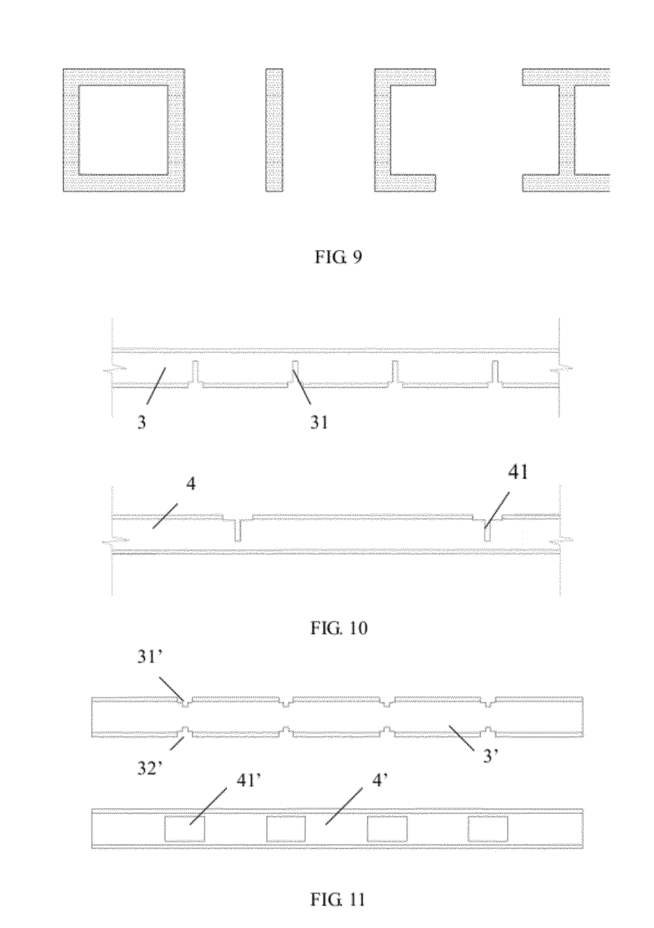

The longitudinal supports 3 and transverse supports 4 are in the shape of a strip. As shown in FIG. 9, the cross sections of the longitudinal supports and transverse supports could also be in the shape of hollow rectangle, solid rectangle, C-shape, or I-shape.

FIG. 10 illustrates an engagement manner between a longitudinal support and a transverse support crossing each other. As shown in FIG. 10, where a cross section of a transverse support is in the shape of solid or hollow rectangle, a corresponding longitudinal support 3 is provided with a plurality of spaced notches 31 at a side thereof facing to the transverse support 4, in which the width of each notch 31 is slightly larger than the thickness of the transverse support 4, while the depth of each notch 31 is slightly larger than a half of the height of transverse support 4. Similarly, where a cross section of the longitudinal support is in the shape of solid or hollow rectangle, the transverse support 4 is provided with a plurality of spaced notches 41 at a side thereof facing to the longitudinal support 3, in which the width of each notch 41 is slightly larger than the thickness of the longitudinal support 3, while the depth of each notch 41 is slightly larger than a half of the height of longitudinal support 3. When the longitudinal support 3 and the transverse support 4 are to be engaged with each other, one notch 31 of the longitudinal support 3 should be inserted into a corresponding notch 41 of the transverse support 4, and thereby the longitudinal support 3 and the transverse support 4 cross each other to form a stable engagement structure.

Similarly, where a cross section of a transverse support is in I-shape or C-shape, a corresponding longitudinal support 3 is provided with a plurality of spaced notches 31 at a side thereof facing to the transverse support 4, in which the width of a top of each notch 31 is slightly larger than the thickness of a top of the transverse support 4, and the width of a bottom of each notch 31 is slightly larger than the thickness of the transverse support 4, while the depth of each notch 31 is slightly larger than a half of the height of transverse support 4. Similarly, where the cross section of a longitudinal support is in I-shape or C-shape, a corresponding transverse support 4 is provided with a plurality of spaced notches 41 at a side thereof facing to the longitudinal support 3, in which the width of a top of each notch 41 is slightly larger than the thickness of a top of the longitudinal support 3, the width of a bottom of each notch 41 is slightly larger than the thickness of the longitudinal support 3, while the depth of each notch 41 is slightly larger than a half of the height of longitudinal support 3. When the longitudinal support 3 and the transverse support 4 are to be engaged with each other, one notch 31 of the longitudinal support 3 should be inserted into a corresponding notch 41 of the transverse support 4, and thereby the longitudinal support 3 and the transverse support 4 cross each other to form a stable engagement structure.

Furthermore, FIG. 11 illustrates another engagement manner between a longitudinal support and a transverse support crossing each other. A cross section of the longitudinal or transverse support could be in the shape of either of hollow rectangle, solid rectangle, C-shape, or I-shape. As shown in FIG. 11, the longitudinal support 3′ is provided with a plurality of spaced upper notches 31′ and spaced lower notches 32′ at a upper and lower side thereof respectively, in which each upper notch 31′ is aligned with a corresponding lower notch 32′. The transverse support 4′ is provided with a plurality of spaced openings 41′ in the middle part of the height of the transverse support along the length thereof. The height of each opening 41′ is slightly larger than the height of the longitudinal support 3′ between a pair of aligned upper and lower notches 31′ and 32′, while the width of the opening 41′ is slightly larger than the maximum height of the longitudinal support 3′. When the longitudinal support 3′ and the transverse support 4′ are to be engaged with each other, the longitudinal support 3′ should be placed horizontally and then be inserted into an opening 41′ of the transverse support 4′. After a pair of upper and lower notches 31′ and 32′ of the longitudinal support 3′ are aligned with the opening 41′, the longitudinal support 3′ is rotated by 90°. Then, the upper and lower notches 31′ and 32′ would be attached to the transverse support 4′, and thereby the longitudinal and transverse supports 3′ and 4′ cross and are engaged with each other. In this engagement manner, the longitudinal and transverse supports may be exchangeable. That is, the longitudinal support is provided with openings, while the transverse support is provided with upper and lower notches.

According to different application situations, the longitudinal and transverse supports could be made of a variety of materials, such as fiberglass-reinforced plastics. Besides, the size of the longitudinal or transverse supports could be adapted according to the uses thereof. Preferably, the thickness of wall of the longitudinal or transverse supports may be 0.1 mm-20 mm, the length may be 25 mm-3000 mm, the width may be 1 mm-200 mm, while the height may be 5 mm-450 mm.

However, if the size of the composite board is small, the composite board of the present invention could only comprise the first and second panel boards and the edge seals mounted along the edges of the first and second panel boards. Between the first and second panel boards, either longitudinal or transverse supporting strips are provided, or even none of the longitudinal and transverse supporting strips are provided.

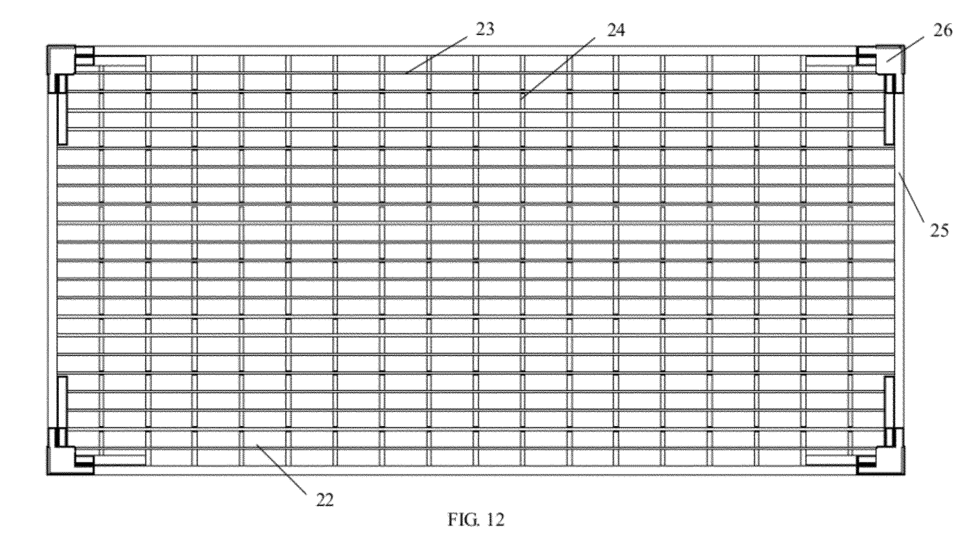

FIG. 12 illustrates a second embodiment of the composite board of the present invention. Similar to the first embodiment, the second embodiment comprises a first panel board (not shown in FIG. 12), a second panel board 22 aligned with the first panel board, one or more longitudinal supports 23 sandwiched between the first and second panel boards, one or more transverse supports 25 sandwiched between the first and second panel boards and crossing the longitudinal supports, and edge seals 25 mounted along the edges of the first and second panel boards. Different from the first embodiment, the second embodiment may further comprise one or more corner protector 26 sandwiched between the first and second panel boards at the corners of the latters.

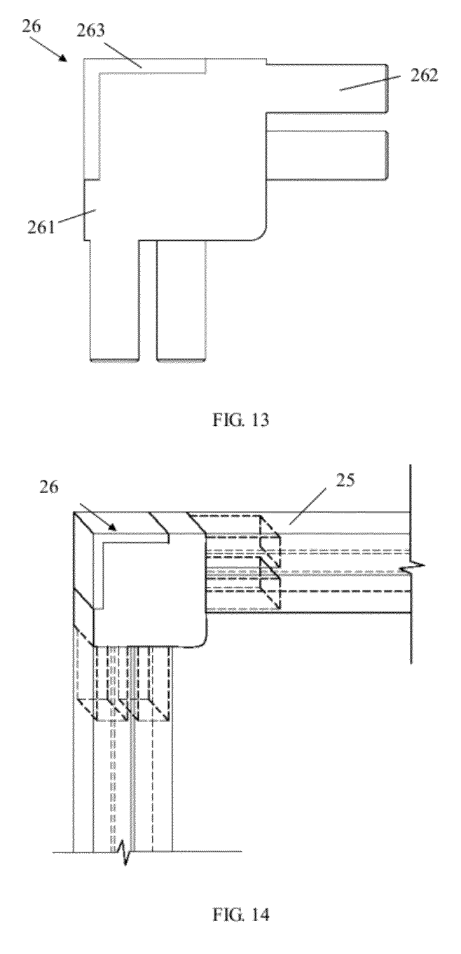

As shown in FIG. 13, the corner protector 26 includes a main body 261, one or more projections 262 extending outwards from adjacent sides of the main body facing to the internal of the composite board, a coating 263 covering exposed sides of the main body. The main body and the projections could be made of a variety of materials, such as fiberglass-reinforced plastics, while the coating could be made of hard materials, such as metals, alloys, etc.

As shown in FIG. 14, when the corner protectors 26 are mounted at the corners of the composite board, the projections 262 thereof is inserted into the through holes of the edge seals 25. If each relevant side of the corner protector 26 is provided more than one projection, those projections could be inserted into more than one through hole of an edge seal respectively, or be inserted into respective through holes of more than one edge seal. As shown in FIG. 10, the length of the more than one edge seal could be different from each other, in which the outermost edge seal could be extended along the whole length of the composite board, while the inner edge seals could be relatively shorter.

The corners of the composite board are the weakest parts thereof, and thereby are subject to damage. After the corner protectors are set at the corners of the composite board, better protection could be provided to the composite board. Therefore, the composite board could be protected from damage even if being dropped from height or impacted forcefully.

Of course, according to different requirements, the corner protector could only comprise a main body and a coating without projections; or could only include a main body without projections and coating. If the corner protector does not include projections, the edge seals used in the composite board could be solid. Although the cross section of the main body of the corner protector shown in FIGS. 3 and 4 is in the shape of rectangle, the cross section thereof could also be in the shape of triangle.

The size of the main body of the corner protector could be adapted according to different uses. Preferably, the length thereof could be 5 mm-200 mm, the width could be 5 mm-200 mm, while the height could be 5 mm-450 mm. At the same time, the length of the projections could also be various. Preferably, the length thereof could be 5 mm-200 mm, while the width and height thereof could be adapted according to the size of the through holes of the relevant edge seals.

The fiberglass-reinforced plastic of the present invention are made of resin matrix reinforced with fibers. The matrix could be made of pure resin or resin with additive. The resin for the matrix could be epoxy resin, unsaturated polyester resin, phenolic resin or furan resin. The additive could be powder of calcium carbonate, speckstone, quartz or insulating glass. The fibers could enhance the strength and rigidity of the composite board.

The composite board of the present invention could further comprise stuffing (not shown in the figures). The stuffing fills the inner space formed by the first panel board, the second panel board and the edge seals, which could further enhance the stability of the composite board. The stuffing could be made of light materials.

The stuffing could be light foam, honeycomb material or softwood.

Light foam could be at least one of expanded polystyrene (EPS), extruded polystyrene (XPS), polyurethane (PU), polyvinylidene chloride (PVC), polyetherimide (PEI), acrylonitrile styrene copolymer (SAN/AS), polymethacrylimide (PMI), thermoplastic polyethylene (PET). If the first and second panel boards are made of fiberglass-reinforced plastics, the light foam could be coated with protective agent made of the mixture of white adhesive cement and speckstone powder. The weight ratio of white adhesive cement and speckstone powder in the mixture could be 1:0.5.

The honeycomb material could be at least one of glass-cloth honeycomb, NOMEX honeycomb, cotton honeycomb, aluminum honeycomb and PVC honeycomb.

The mechanical performance and operation of the present composite board are similar to the wood boards or plywood. Therefore, the composite board of the present invention could widely replace various boards used in construction and decoration, such as solid wood boards, plywood, middle-density fiber boards and particle boards etc., and could also replace wood, brackets, doors, or could even be used as beams, pillars, floors or walls.

Although some embodiments of the present invention have been shown and described with reference to the accompanying drawings, those skilled in the art should understand that various changes and modifications can be made to the embodiments without departing the principles and spirits of the present invention and they still fall into the scope of claims and the equivalent thereof.

What is claimed is:

1. A composite board comprising:
a first panel board;
a second panel board aligned with the first panel board; and
edge seals mounted along edges of the first panel board and the second panel boards.

2. The composite board according to claim 1, wherein the first and second panel boards comprise fiberglass-reinforced plastics.

3. The composite board according to claim 1, wherein the edge seals are edge sealing strips located between the first and second panel boards; and each edge of the first and second panel board is provided with one or more edge sealing strips; the outermost edge sealing strip extends along the whole length of the edge to close the edge; and the inner edge sealing strips extend along the whole length or part of length of the edge.

4. The composite board according to claim 3, wherein the edge sealing strips comprise fiberglass-reinforced plastics.

5. The composite board according to claim 3, wherein a cross section of each edge sealing strip is in the shape of solid rectangle, hollow rectangle, I-shape or C-shape.

6. The composite board according to claim 1 further comprising one or more supports located between the first and second panel boards.

7. The composite board according to claim 6, wherein the supports include longitudinal supporting strips and transverse supporting strips, that intersect the longitudinal supporting strips.

8. The composite board according to claim 7, wherein either the longitudinal supporting strips or the transverse supporting strips have a cross section in the shape of hollow rectangle or solid rectangle; each of the other of the longitudinal and transverse supporting strips is provided with spaced notches at a side thereof, wherein the spaced notches face either the longitudinal supporting strips or the transverse supporting strips; the number of the notches is the same as the number of said either the longitudinal supporting strips or the transverse supporting strips; the width of each notch is slightly larger than the thickness of each of said either the longitudinal supporting strips or the transverse supporting strips, and the depth of each notch is slightly larger than a half of the height of each of said either the longitudinal supporting strips or the transverse supporting strips; and each longitudinal supporting strip and each transverse supporting strip are engaged with each other at corresponding notches.

9. The composite board according to claim 7, wherein either the longitudinal supporting strips or the transverse supporting strips have a cross section in I-shape or C-shape; each of the other of the longitudinal and transverse supporting strips is provided with spaced notches at a side thereof, wherein the spaced notches face either the longitudinal supporting strips or the transverse supporting strips; the number of the notches is the same as the number of said either the longitudinal supporting strips or the transverse supporting strips, the width of a top of each notch is slightly larger than the thickness of a top of each of said either the longitudinal supporting strips or the transverse supporting strips, the width of a bottom of each notch is slightly larger than the thickness of each of said either the longitudinal supporting strips or the transverse supporting strips, and the depth of each notch is slightly larger than a half of the height of each of said either the longitudinal supporting strips or the transverse supporting strips; and each longitudinal supporting strip and each transverse supporting strip are engaged with each other at corresponding notches.

10. The composite board according to claim 7, wherein a cross section of each longitudinal and transverse supporting strip is in the shape of solid rectangle, hollow rectangle, I-shape or C-shape; each longitudinal supporting strip is provided with a plurality of spaced upper notches and a plurality of spaced lower notches at a upper and lower side thereof respectively and each upper notch is aligned with a corresponding lower notch, each transverse supporting strip is provided with a plurality of spaced openings in the middle part of the height thereof along its length, in which the height of each opening is slightly larger than the height of the longitudinal supporting strip between a pair of aligned upper and lower notches; and the width of the opening is slightly larger than the maximum height of the longitudinal supporting strip, and a pair of the upper and lower notches of one of the longitudinal supporting strips are attached to one of the transverse supporting strips within a corresponding opening to enable the longitudinal supporting strip and the transverse supporting strip to be engaged with each other.

11. The composite board according to claim 6, wherein the supports comprise fiberglass-reinforced plastics.

12. The composite board according to claim 6, wherein the edge seals comprise marble glue, epoxy resin, unsaturated polyester resin located in the edges of the first and second panel boards.

13. The composite board according to claim 6, wherein the edge seals are exterior edge seals attached to a periphery of the first and second panel boards to close an inner space between the first and second panel boards, and each of the exterior seals comprises:
a main body attached to the periphery of the first and second panel boards, and
a protrusion extending from a side of the main body facing to the first and second panel boards towards the first and second panel boards for supporting the outer surface of the first or second panel board.

14. The composite board according to claim 13, wherein the exterior edge seals comprise fiberglass-reinforced plastics.

15. The composite board according to claim 6, wherein each of the edge seals comprises:
a side strip attached to a periphery of the first and second panel boards,
a plurality of upper protrudes are located at a upper part of the side strip and spaced from each other, and
a plurality of lower protrudes are located at a lower part of the side strip and aligning with the upper protrudes,
wherein both the upper protrudes and the lower protrudes extend from a side of the side strip facing to the first and second panel boards towards an inner space between the first and second panel boards, to supporting inner surfaces of the first and second panel boards.

16. The composite board according to claim 15, wherein the edge seals comprise fiberglass-reinforced plastics.

17. The composite board according to claim 1 further comprising corner protectors located between the first and second panel boards at corners thereof, and each corner protector includes a main body comprising fiberglass-reinforced plastics.

18. The composite board according to claim 17, wherein each corner protector further includes a coating covering exposed sides of the main body, and the coating comprises metals or alloys.

19. The composite board according to claim 17, wherein the main body of each corner protector has a cross section in the shape of triangle or rectangle.

20. The composite board according to claim 3, wherein a cross section of each edge seal is in the shape of hollow rectangle, and the composite board further comprises corner protectors located between the first and second panel boards at corners of the lattes, in which each corner protector includes a main body made of fiberglass-reinforced plastics, and the main body has a cross section in the shape of rectangle, and each corner protector further comprises one or more projections extending outwards from adjacent sides of the main body facing to the internal of the composite board, wherein the projections are inserted into through holes of the edge seals.

21. The composite board according to claim 20, wherein each corner protector further includes a coating covering exposed sides of the main body, and the coating comprises of metals or alloys.

22. The composite board according to claim 1 further comprising stuffing filling an inner space formed between the first and second panel boards, in which the stuffing is made of light foam and the light foam is selected from the group consisting of expanded polystyrene, extruded polystyrene, polyurethane, polyvinylidene chloride, polyetherimide, acrylonitrile styrene copolymer, polymethacrylimide and thermoplastic polyethylene.

23. The composite board according to claim 22, wherein the light foam is coated with protective agent comprises white adhesive cement and speckstone powder.
